(19) United States
(12) Patent Application Publication
(10) Pub. No.: US 2009/0091747 A1
(43) Pub. Date: Apr. 9, 2009

(54) Edge flaw detection device

(76) Inventors: Naoyuki Nohara, Tokyo (JP); Hideo Sakai, Tokyo (JP)

Correspondence Address: NIXON & VANDERHYE, PC, 901 NORTH GLEBE ROAD, 11TH FLOOR, ARLINGTON, VA, 22203, US

(21) Appl. No.: 11/989,596

(22) PCT Filed: Aug. 10, 2005
(86) PCT No.: PCT/JP2005/014663

§ 371 Date: Jan. 29, 2008

(51) Int. Cl. G01N 21/00

(52) U.S. Cl. 356/237.2

(57) ABSTRACT

An edge flaw detection device includes an elliptical mirror having an inner mirror surface, with a cut-out formed in the vertex portion to enable insertion of an object; a light-emitting portion which radiates coherent light toward an edge of the object, the edge of the object being positioned in the vicinity of a first focal position of the elliptical mirror; an optical detector positioned at a second focal position of the elliptical mirror; and a light-blocking member which blocks lower-order diffracted light which is regularly reflected. The light-emitting portion is capable of radiating coherent light at different wavelengths.

### TECHNICAL FIELD

The present invention relates to an edge flaw detection device which optically detects flaws in the edge of an object.

### BACKGROUND ART

A detection device using an elliptical mirror has been proposed, as an edge flaw detection device, which detects long, narrow edge cracks, fissures, polishing flaws, and other flaws in edges such as the outer peripheral edges of silicon wafers. For example, a device has been proposed in which a light-absorbing member is placed on the mirror face of an elliptical mirror, and lower-order diffracted light which is regularly reflected light is absorbed within the light-absorbing member, and only higher-order diffracted light, irregularly reflected by flaws at the edge, are detected by an optical detector provided at a second focal position (see for example Patent Reference 1). In addition, a device has been proposed in which, apart from a first optical detector provided at a second focal position, a second optical detector is provided in the vicinity of the object installed in the first focal position, enabling detection for vertical flaws and horizontal flaws by means of two light-receiving portions (see for example Patent Document 2). By means of such edge flaw detection devices, the entire perimeter of the edge can be detected by rotating the object, and the presence or absence of flaws, as well as the position in the circumferential direction of any flaws, can be determined through the intensity of light detected by the light-receiving portions.

However, while by means of such edge flaw detection devices of the prior art it has been possible to infer the kind of flaws to some degree through the intensity of light detected by light-receiving portions, there have been limits to the ability to identify the size, type, and other details of flaws from the single measurement quantity of light intensity.

Patent Document 1: Japanese Unexamined Patent Application, First Publication, No. 2003-287412

Patent Document 2: Japanese Unexamined Patent Application, First Publication, No. H11-351850

### DISCLOSURE OF INVENTION

The present invention has been devised in light of the above circumstances, and proposes an edge flaw detection device which enables detection of the size, type, and other details of flaws occurring in the edge of an object.

This invention provides an edge flaw detection device including an elliptical mirror having a mirror surface on an inside thereof; a light-emitting portion which radiates coherent light toward an edge of an object, the edge of the object being positioned in a vicinity of a first focal position of the elliptical mirror; an optical detector which is positioned at a second focal position of the elliptical mirror, and which is capable of detecting diffracted light resulting when the irradiated coherent light is reflected by the edge of the object and by the elliptical mirror so as to arrive at the second focal position; a light-blocking member which blocks lower-order diffracted light which is regularly reflected among the diffracted light; and, a holding portion which holds the object, and which can move the edge in a circumferential direction through the first focal position, the light-emitting portion being capable of radiating the coherent light at different wavelengths.

By means of an edge flaw detection device of this invention, coherent light at various wavelengths is irradiated and the intensity of diffracted light is detected by an optical detector, so that detection of minute flaws, as well as detection of flaws which could not be detected due to substantial absorption of long-wavelength coherent light, and flaws which scatter only coherent light at particular wavelengths, becomes possible.

By means of this invention, through the use of coherent light of different wavelengths, detection of minute flaws, as well as detection of flaws which could not be detected due to substantial absorption of long-wavelength coherent light, and flaws which scatter only coherent light at particular wavelengths, becomes possible, so that detailed detections which identify the sizes and types of flaws can be realized.

### BRIEF DESCRIPTION OF THE DRAWINGS

FIG. 1 is a longitudinal cross-sectional view of an edge flaw detection device according to an embodiment of the invention, taken along its vertical plane.

FIG. 2 is a longitudinal cross-sectional view of an edge flaw detection device according to the embodiment of the invention, taken along its horizontal plane.

FIG. 3 is explanatory view of the edge of the object irradiated by the light-emitting portion according to the embodiment of the invention.

FIG. 4 is a graph showing an example of detection results by an optical detector according to the embodiment of the invention, when the wavelength of irradiating coherent light is changed.

FIG. 5 is a graph showing an example of detection results by an optical detector according to the embodiment of the invention, when the range of irradiation in the thickness direction by coherent light of a plurality of wavelengths is changed.

### BEST MODE FOR CARRYING OUT THE INVENTION

### First Embodiment

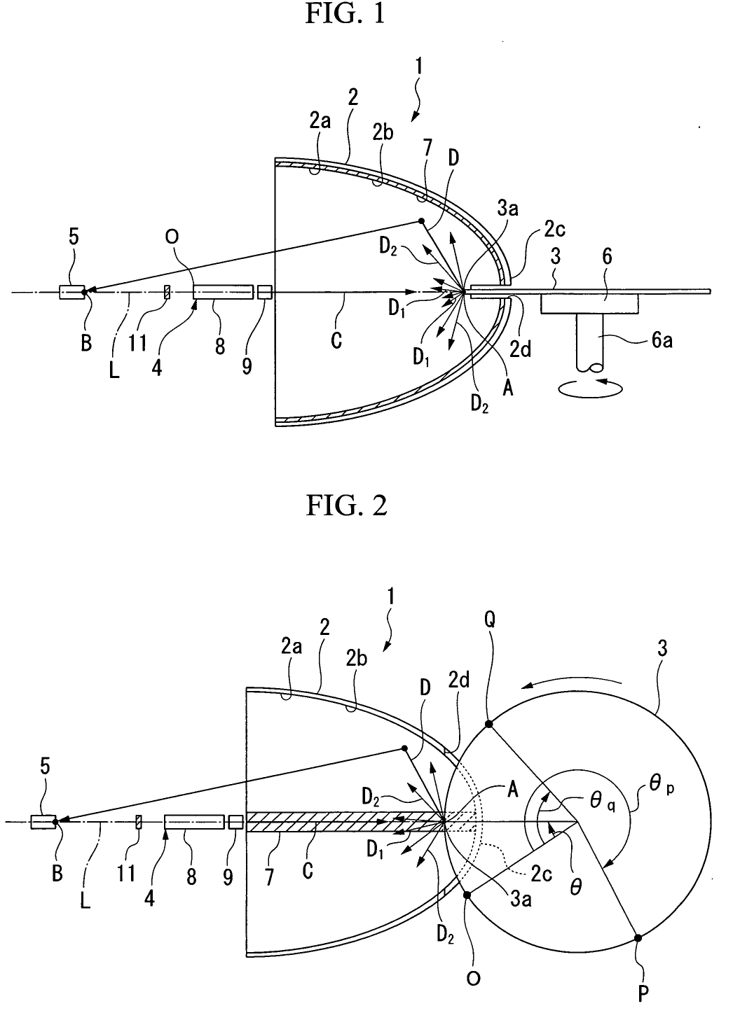

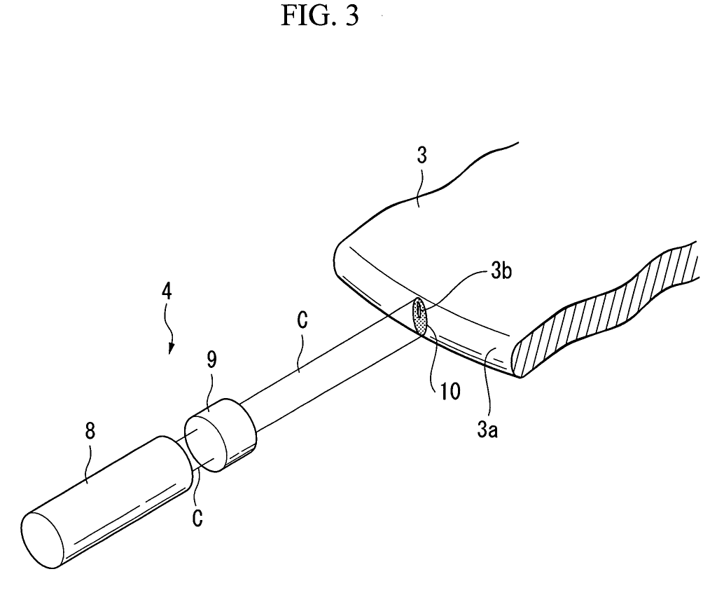

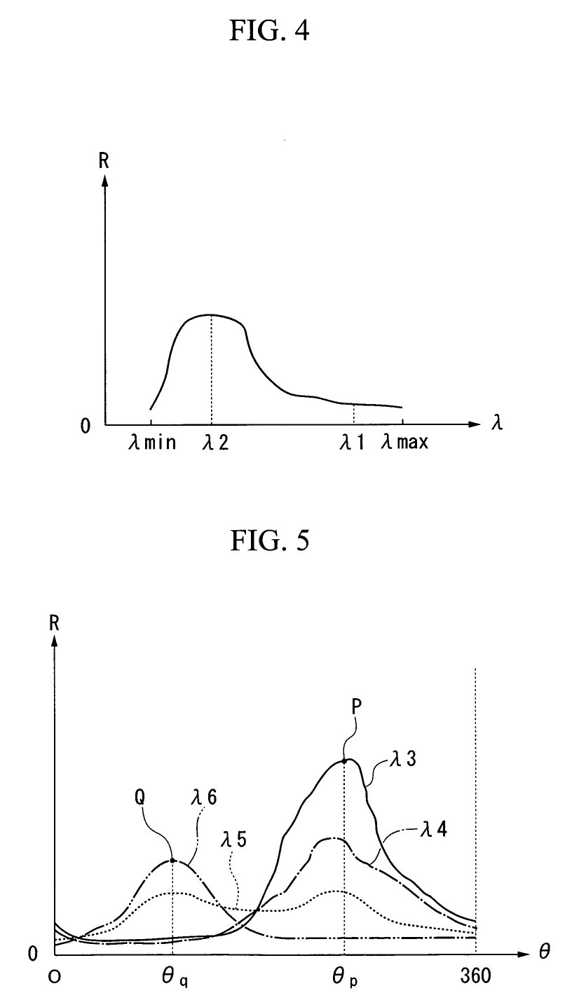

FIG. 1 through FIG. 5 present an embodiment of the invention. FIG. 1 is a longitudinal cross-sectional view of an edge flaw detection device taken along its vertical plane; FIG. 2 is a longitudinal cross-sectional view taken along a horizontal plane. FIG. 3 is explanatory view of the edge of an object irradiated by a light-emitting portion. FIG. 4 is a graph showing an example of detection results by an optical detector when the wavelength of irradiating coherent light is changed, and FIG. 5 is a graph showing an example of detection results by an optical detector when the range of irradiation in the circumferential direction by coherent light of a plurality of wavelengths is changed.

As shown in FIG. 1 and FIG. 2, the edge flaw detection device 1 has an elliptical mirror 2 having a mirror surface 2b on the inside 2a, and at the vertex portion 2c of which is formed a cutout 2d enabling insertion of the object 3; a light-emitting portion 4 which irradiates the edge 3a of the object 3 positioned in the vicinity of the first focal position A of the elliptical mirror 2, with coherent light C along the axial line L in the major-axis direction of the elliptical mirror 2; and an optical detector 5 positioned at the second focal position B of the elliptical mirror 2. Further, the edge flaw detection device 1 includes a holding portion 6 which rotatably holds the object 3, and light-blocking member 7 provided on the elliptical mirror 2. The object 3 is for example a sheet-shape silicon wafer, semiconductor wafer, or similar.

As shown in FIG. 3, the light-emitting portion 4 includes a light source 8 which emits coherent light C, and condensing member 9 which optically acts on the radiated coherent light C. The light source 8 is for example laser light, the wavelength of which can be freely adjusted. More specifically, He—Ne lasers or semiconductor lasers are used; by enabling switching between a plurality of lasers with different wavelengths, the wavelength can be freely adjusted. Alternatively, a variable-wavelength laser may be used for the light source 8. The condensing member 9 can irradiate the entirety of the edge 3a in the thickness direction of the object 3 when coherent light C emitted from the light source 8 irradiates the edge 3a of the object 3, and is a lens which narrows the irradiated range 10 to a narrow width in the circumferential direction, and more specifically is a Fresnel lens. As shown in FIG. 1 and FIG. 2, the optical detector 5 detects diffracted light D which has been radiated from the light-emitting portion 4, reflected by the edge 3a of the object 3, then reflected by the elliptical mirror 2, and condensed at the second focal position B, and is for example a photodiode.

As shown in FIG. 1 and FIG. 2, the holding portion 6 positions the edge 3a of the object 3 in proximity to the first focal position A of the elliptical mirror 2, and, through rotation of the rotating shaft 6a, can cause the edge 3a of the object 3 to move in the circumferential direction past the first focal position A. Further, the light-blocking member 7 is masking tape, having a prescribed width, affixed over the intersecting line where the plane parallel to the thickness direction of the object 3, including the first focal position A and second position B, and the elliptical mirror 2 intersect with each other. Diffracted light D reaching this light-blocking member 7 does not reflected and thus does not reach the optical detector 5 since it is absorbed by the light-blocking member 7. Further, a light-blocking plate 11 is provided on the side of the first focal position A from the optical detector 5. This is provided to prevent coherent light C, radiated from the light-emitting portion 4, from being reflected by the edge 3a of the object 3 and becoming diffracted light D, but then directly reaching the optical detector 5 without being reflected by the elliptical mirror 2.

Next, the action of this edge flaw detection device 1 is explained. The light-emitting portion 4 irradiates an arbitrary position of the edge 3a of the object 3. When a flaw is not included in the irradiated portion, the irradiating coherent light C is regularly reflected, and becomes lower-order diffracted light D1. As shown in FIG. 2, lower-order diffracted light D1 has as a path the vicinity of the axial line L of the plane-view elliptical mirror 2, directed toward the second focal position B, and as shown in FIG. 1, there is some broadening in the thickness direction according to the shape of the edge 3a of the side-view object 3. Hence lower-order diffracted light D1 is absorbed by the light-blocking member 7 or by the light-blocking plate 11, and much of this light does not reach the optical detector 5. That is, when no flaws exist in the edge 3a of the object 3, the intensity R of light detected by the optical detector 5 is measured at only low levels. As shown in FIG. 3, when a flaw 3b is included in the irradiated range 10, the irradiated coherent light C is irregularly reflected, becoming higher-order diffracted light D2. As shown in FIG. 1 and FIG. 2, higher-order diffracted light D2, in both plane view and side view, is scattered over a broad range by a flaw 3b formed in the edge 3a and is reflected by the elliptical mirror 2, arriving at the optical detector 5 at the second focal position B. That is, when a flaw 3b exists in the edge 3a of the object 3, the intensity R of light detected by the optical detector 5 is measured to be at a high level. When the size of the flaw 3b is minute relative to the wavelength λ of the irradiating coherent light C, or, in the case of damage or similar for which there is no reflection except at a specific wavelength λ, the irradiated coherent light C is regularly reflected, and becomes lower-order diffracted light D1 which is not detected by the optical detector 5. That is, it is judged that no flaws 3b exist in the edge 3a of the object 3. FIG. 4 shows an example of the relation between the wavelength λ when the wavelength λ is changed during irradiation and the intensity R of light detected by the optical detector 5, for an arbitrary position of the edge 3a of the object 3. As shown in FIG. 4, by changing the wavelength λ, a flaw which could not be detected at wavelength λ1 can be detected at a wavelength λ2 shorter than wavelength λ1. FIG. 5 shows an example of the relation between the rotation angle θ of the object 3 and the intensity R of light detected by the optical detector 5, for a case in which the wavelength λ is changed, and moreover the edge 3a of the object 3 is rotated through 360° by the holding portion 6. The rotation angle θ denotes the angle taking position O to be 0°, and taking right-rotation to be positive, as indicated in FIG. 2. As shown in FIG. 5, each of the graphs represents the relations when the wavelength is λ3, λ4, λ5, and λ6; these wavelengths λ have the magnitude relationship λ3<λ4<λ5< 6. As shown in FIG. 2 and FIG. 5, in this example higher-order diffracted light D2 of wavelength λ, arising from a flaw, can be detected prominently in the vicinity of the rotation angle θp of position P, and higher-order diffracted light D2 of wavelength λ, arising from a flaw, can be detected prominently in the vicinity of the rotation angle θq of position Q. By thus changing the wavelength λ when performing detections, even minute flaws can be detected, and moreover flaws which could not be detected due to substantial absorption of long-wavelength coherent light, and flaws and damage which can only be detected at specific wavelengths, can also be identified.

As explained above, by irradiating using coherent light C at different wavelengths λ, the edge flaw detection device 1 can identify not only the presence of flaws, but also the flaw size and flaw type through the wavelength λ and the intensity R of light detected by the optical detector 5.

In the above, an embodiment of the invention has been explained in detail referring to the drawings; however, specific configurations are not limited to this embodiment, and design modifications and similar which do not deviate from the gist of the invention are also included.

Here, the edge 3a of the object 3 was irradiated with coherent light C along the optical axis L of the elliptical mirror 2; but other configurations are possible. In place of this, the optical axis of the light source 8 may be positioned shifted somewhat (approximately 4°) relative to the axial line L of the elliptical mirror 2, such that the light source 8 and the second focal point B do not coincide. By this means, lower-order diffracted light D1, resulting from specular reflection by the edge 3a of the object 3 of irradiated coherent light, is shifted from the axial line L of the elliptical mirror 2, so that the light-blocking plate 11 can be omitted.

In this case, the optical axis of the light source 8 may be inclined in a horizontal direction relative to the axial line L of the elliptical mirror 2, but it is preferable that the inclination be in a vertical direction. That is, when an edge 3a of the horizontally supported object 3 is irradiated with coherent light C from a direction inclined in a horizontal direction relative to the axial line L of the elliptical mirror 2, scattered reflected light in the lateral direction containing much information necessary for damage identification is biased in the lateral direction, and there is the problem that useful information is lost. On the other hand, in the case of inclination in the vertical direction, vertical-direction scattered reflected light does not contain much information necessary for damage identification, so that the above-described problem does not tend to occur. Even when using inclination in a horizontal direction, through special measures, such as employing an elliptical mirror 2 with a shape which is laterally asymmetrical, lateral-direction scattered reflected light can be condensed at the optical detector.

As the light-blocking member 7, masking tape affixed to the elliptical mirror 2 is employed; but other means may be used. It is sufficient that regularly reflected lower-order diffracted light D1 be blocked; for example, as a spatial filter between the edge 3a of the object 3 and the light source 8, a light-blocking plate of prescribed width may be positioned so as to abut the inside face of the elliptical mirror 2 in the vertical direction perpendicularly intersecting the plane of the object 3. By this means, lower-order diffracted light D1 is blocked by the light-blocking plate, but higher-order diffracted light D2 escapes around the light-blocking plate and is condensed by the elliptical mirror 2.

### INDUSTRIAL APPLICABILITY

By means of coherent light with different wavelengths, minute flaws and flaws which could not be detected due to substantial absorption of long-wavelength coherent light, as well as flaws which irregularly reflect only coherent light of a specific wavelength, can be detected, and the size and type of flaws can be identified, so that detailed edge flaw detections can be realized.

1. An edge flaw detection device comprising:
an elliptical mirror having a mirror surface on an inside thereof;
a light-emitting portion which radiates coherent light toward an edge of an object, the edge of the object being positioned in a vicinity of a first focal position of the elliptical mirror;
an optical detector which is positioned at a second focal position of the elliptical mirror, and which is capable of detecting diffracted light resulting when the radiated coherent light is reflected by the edge of the object and by the elliptical mirror so as to arrive at the second focal position;
a light-blocking member which blocks lower-order diffracted light which is regularly reflected among the diffracted light; and,
a holding portion which holds the object, and which can move the edge in a circumferential direction through the first focal position,
the light-emitting portion being capable of radiating the coherent light at different wavelengths.
